(19) United States
(12) Patent Application Publication
(10) Pub. No.: US 2026/0192690 A1
(43) Pub. Date: Jul. 9, 2026

(54) ISOLATED SINGLE CIRCUIT FOR HIGH VOLTAGE DC BUS VOLTAGE SENSING AND PASSIVE DISCHARGING

(71) Applicant: FORD GLOBAL TECHNOLOGIES, LLC, Dearborn, MI (US)

(72) Inventors: Petros G. Taskas, Novi, MI (US); Baoming Ge, Okemos, MI (US)

(21) Appl. No.: 19/009,477

(22) Filed: Jan. 3, 2025

(51) Int. Cl. B60L 53/22; B60L 3/00; B60L 50/52

(52) U.S. Cl. CPC B60L 53/22; B60L 3/0069; B60L 50/52; B60L 2210/40; B60L 2240/427

(57) ABSTRACT

Certain disclosed technology relates to automotive power systems and methods for energy management and voltage monitoring. A system includes a traction battery, a resistor bank, an inverter electrically connected between the battery and resistor bank, and a capacitor positioned to stabilize voltage. Circuitry integrated into the system features an optocoupler driven by the current through the resistor bank, generating an output voltage that is electrically isolated from the inverter and indicative of the traction battery's voltage. A method involves using the optocoupler to produce an output voltage reflective of the DC bus voltage, achieved through the resistor bank connected in parallel with the traction battery. Additionally, the system supports current monitoring with the optocoupler providing output current proportional to the current flowing through the resistor bank and DC bus.

### TECHNICAL FIELD

This disclosure relates to high-voltage power electronics systems for automotive vehicles.

### BACKGROUND

High-voltage (HV) power systems are integral to the operation of electric vehicles (EVs) and hybrid electric vehicles (HEVs). These systems typically operate at voltages ranging from 300 to 800 volts or higher, providing the necessary power density to drive electric motors, recharge batteries, and support energy-intensive components such as air conditioning, regenerative braking, and on-board chargers. HV power systems often include a HV battery, which serves as the primary energy storage unit, delivering DC power to an inverter. The inverter converts HV DC power into multi-phase AC power to drive the motor, which transforms electrical energy into mechanical energy for propulsion.

### SUMMARY

A vehicle includes an electrical system for energy management and monitoring. The system comprises a traction battery, a resistor bank, an inverter electrically connected between the battery and resistor bank, and a capacitor positioned between the traction battery and inverter. Additionally, the system incorporates circuitry including an optocoupler, which is driven by the current through the resistor bank. This arrangement produces an output voltage that is electrically isolated from the inverter and provides an indication of the traction battery's voltage.

A method involves generating an output voltage that reflects the DC bus voltage of an automotive power system. This is achieved using circuitry that includes an optocoupler, which is driven by the current through a resistor bank connected in parallel with a traction battery. The system is configured such that an inverter is electrically connected between the resistor bank and the traction battery.

An automotive power system includes a motor powered by a traction battery and an inverter connected via a DC bus. A resistor bank is connected across the DC bus to facilitate current flow monitoring. The system further incorporates an optocoupler configured to generate an output current proportional to the current flowing through the resistor bank and the DC bus.

### BRIEF DESCRIPTION OF THE DRAWINGS

FIG. 1 is a schematic diagram of a high voltage power system.

FIG. 2 is a schematic diagram of another high voltage power system.

### DETAILED DESCRIPTION

Detailed embodiments of the present disclosure are provided herein. These embodiments, however, are merely examples and that the concepts described may be implemented in various alternative forms and configurations. The figures included are not necessarily drawn to scale, and certain features may be exaggerated or simplified to better illustrate specific aspects of particular components. As such, the structural and functional details provided in this disclosure are not intended to be limiting but rather serve as representative examples to guide those skilled in the art in applying these concepts in different ways.

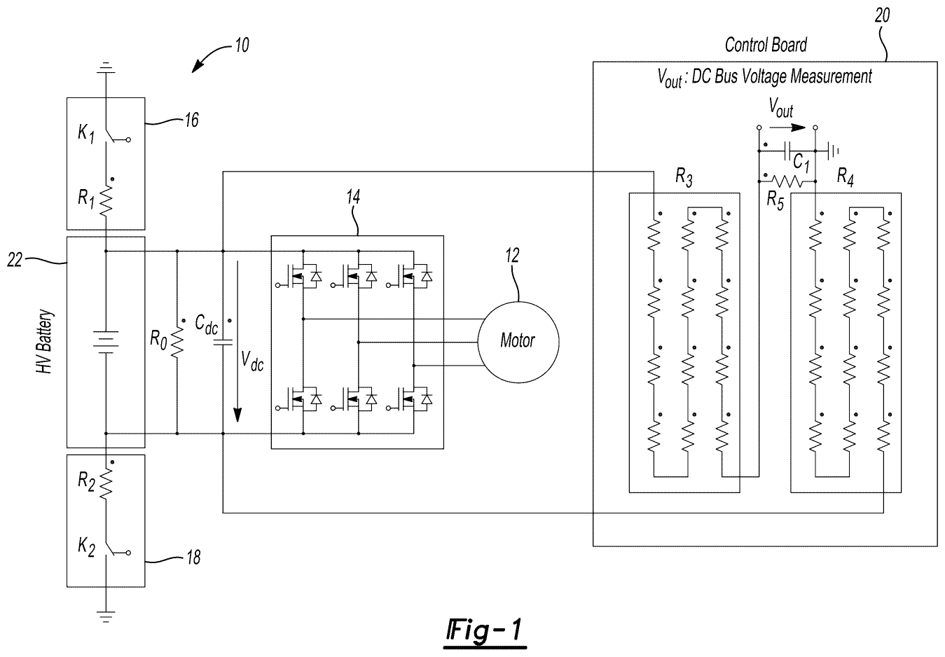

EVs may rely on an inverter system controller (ISC) to control electrical power flow to the motor, enabling vehicle propulsion and battery charging. The ISC employs power semiconductor devices, such as insulated gate bipolar transistors (IGBTs) or silicon carbide (SiC) devices, for efficient energy conversion. During operation, the ISC monitors the HV DC bus voltage through a high voltage sensing circuit on the control board. This circuit, as depicted in FIG. 1, utilizes a network of series-connected resistors and a capacitor to step down and measure the HV DC bus voltage. In addition to voltage sensing, the HV battery controller performs a HV isolation check to detect and ensure that leakage currents remain below a threshold.

A HV battery-powered system 10 includes a motor 12, an inverter 14, leakage current detection circuits 16, 18, a control board 20 designed for DC bus voltage measurement, and a central power source 22 (e.g., a HV battery).

A control board, in some examples, is a component that manages and controls power flow for subsystems such as inverters and converters. It may be constructed as a multi-layer printed circuit board (PCB) that integrates signal processing with power-handling capabilities. The PCB layers include a power plane for power distribution, signal layers for routing low-power control signals, and a ground plane to suppress noise and electromagnetic compatibility (EMC). Components on the board may include microcontrollers or digital signal processors (DSPs) for real-time computations, gate drivers for interfacing with high-power switching devices, sensors for monitoring parameters like voltage, current, and temperature, and communication modules that support standard automotive protocols like CAN or LIN. The board may also incorporate protection circuits for overvoltage, overcurrent, and thermal conditions, alongside capacitors and inductors for signal filtering and stabilization. Connectors may link the board to power modules, sensors, and actuators, while thermal management may be achieved through heat sinks, thermal vias, and conformal coatings to handle the heat generated by high-power components.

The operation of a control board may involve acquiring, processing, and acting on real-time data to control power electronics systems. Sensors provide continuous feedback on voltage, current, and temperature, which are fed into analog-to-digital converters (ADCs) or dedicated inputs. The microcontroller or DSP processes this data using algorithms, such as pulse-width modulation (PWM) or field-oriented control (FOC) for control of motor speed, torque, or energy flow. Based on this processing, the board determines the switching sequence for the inverter or converter. Gate drivers then translate these decisions into high-speed, high-power signals to drive switches. Feedback loops maintain operational parameters, adjusting system performance dynamically in response to changing loads or conditions. Additionally, the control board communicates with the vehicle's electronic control unit (ECU) and other systems for diagnostic monitoring, software updates, or coordinated operation across the vehicle.

The HV battery 22 delivers DC voltage Vdc to the inverter 14 for motor operation. The battery 22 is equipped with the two separate leakage current detection circuits 16, 18 for monitoring. On the positive terminal of the HV battery 22, the detection circuit 16 includes a switch K1 in series with a resistor R1 that enables the identification of leakage currents by providing a path to ground. Similarly, the negative terminal of the battery 22 features the other detection circuits 18 with a switch K2 and a resistor R2. The circuits 16, 18 monitor and mitigate leakage currents.

Directly connected to the HV battery 22 is a parallel combination of a resistor R0 and a capacitor Cdc across the DC bus. This configuration serves as a filtering network. The resistor R0 helps to discharge the capacitor Cdc to less than, for example, 60V in 60 seconds. The capacitor Cdc stabilizes the DC bus voltage by filtering out high-frequency noise and ripple, resulting in a steady voltage supply to the downstream inverter 14.

The inverter 14, a component of the system 10, comprises a series of semiconductor switches configured in a three-phase full-bridge topology. Each switch is paired with a freewheeling diode, which conducts current during the off state of the switch, maintaining continuous current flow and protecting the switches during transient events. The inverter 14 is responsible for converting the DC voltage from the battery 22 into a three-phase AC voltage suitable for driving the motor 12. The generated AC voltage is delivered to the motor 12, which converts the electrical energy into mechanical energy, propelling the vehicle (not shown).

On the control side, the DC bus voltage is continuously monitored by a control board 20. The voltage measurement system begins with a resistor divider network, comprising resistors R3, R4, and R5, arranged in series arrays to divide the high voltage of the DC bus down to a level compatible with the measurement electronics. The values of these resistors are selected based on the voltage range of the system and the input specifications of the control circuit. The output of this divider is further conditioned using a filtering network that includes a resistor R5 and a capacitor C1. This filter smooths out any noise or fluctuations in the signal so the control board 20 receives a stable and accurate representation of the DC bus voltage. The resulting output voltage Vout is used by the control system for monitoring or feedback control.

Issues in the high voltage sensing circuit and high voltage isolation detection circuit have been observed during operation and ISC high-voltage laboratory isolation tests. One recurring issue affects the capacitor C1, which occurs under specific conditions, such as during leakage current detection or when applying 1000 Vdc between the HV DC bus and the ISC housing during isolation tests. This issue arises from several factors. First, the HV sensing circuit lacks electrical isolation, leaving the capacitor C1 susceptible to stress. Second, the voltage rating of C1 is based on the expected output voltage Vout, calculated under normal operating conditions as Vdc*R5/(R5+2R3), where R3=R4. While the capacitor's voltage rating includes a design margin above this expected value, the actual voltage across C1 increases under certain conditions. For example, during leakage current detection or isolation tests, Vout changes to Vdc*R5/(R5+R3), exceeding its typical value and potentially subjecting the capacitor to overvoltage, leading to issues.

For additional functionality, the ISC includes a passive discharge circuit with the resistor R0 designed to reduce the HV capacitor voltage to below 60 V within 60 seconds in the event of system shutdown. However, the system lacks a mechanism to detect an open circuit in the discharge circuit.

Here, architectures are proposed that implement HV DC bus voltage sensing and HV capacitor passive discharging with an open circuit fault report function by a single isolated circuit.

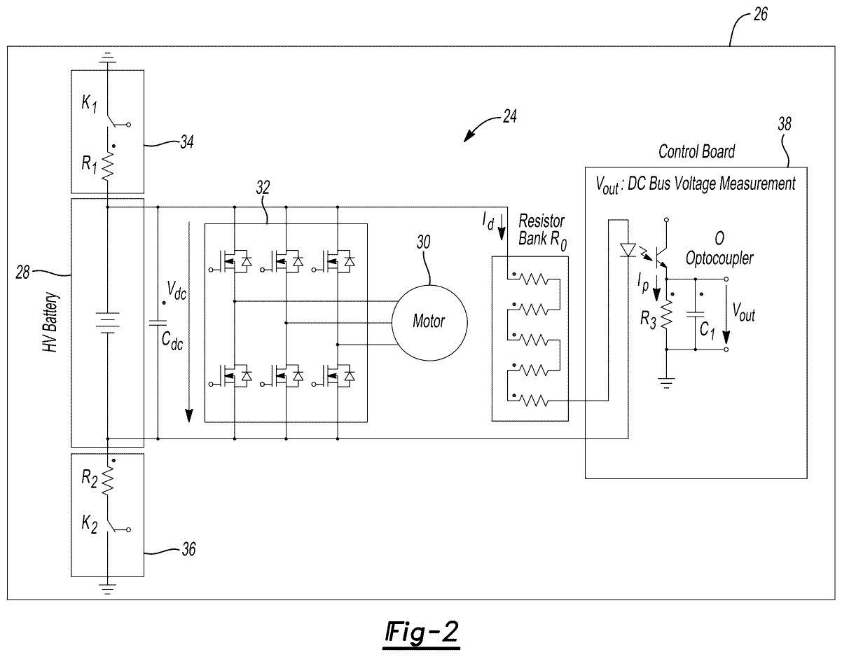

The schematic of FIG. 2 illustrates a HV electrical system 24 for an electric vehicle 26, which includes a HV battery 28, a motor 30, an inverter 32, leakage current detection circuits 34, 36, and a control board 38 for DC bus voltage measurement. The system 24 integrates monitoring and operational functionalities with components interconnected for operation.

The HV Battery 28 serves as the main power source, supplying the high-voltage DC bus Vdc that powers the motor 30. The leakage current detection circuits 34, 36 monitor for insulation faults. On the positive terminal, the circuit 34 includes a switch K1 and a resistor R1 connected in series, allowing for the detection of leakage current by providing a controlled path to ground. Similarly, the negative terminal includes the detection circuit 36 with a switch K2 and a resistor R2.

The DC bus is connected to the motor 30 through the inverter 32, which comprises a configuration of semiconductor switches. These switches, represented in a half-bridge or full-bridge arrangement, convert the HV DC voltage into three-phase AC voltage to drive the motor 30. Each switch is paired with freewheeling diodes to permit continuous current flow and protect the circuit during switching transients. The motor 30 receives this three-phase AC voltage and converts electrical energy into mechanical energy for vehicle propulsion.

A capacitor Cdc is placed across the DC bus to stabilize the voltage Vdc by filtering out high-frequency noise and ripple. The capacitor Cdc enables a smooth and consistent voltage supply to the inverter 32 and motor 30, preventing fluctuations that could affect performance or efficiency. Additionally, a resistor bank R0, which can be outside or on the control board 38, is connected in parallel with the DC bus. This passive discharge circuit is designed to discharge the HV capacitor voltage to below, for example, 60 V within 60 seconds, particularly in the event of a system shutdown.

The control board 38 permits real-time monitoring of the DC bus voltage. The voltage measurement system utilizes an optocoupler O to provide electrical isolation between the high-voltage components and the low-voltage control electronics. The optocoupler O receives a proportional input current Ip, which goes through the voltage divider network. This network includes a phototransistor, a resistor R3, and a capacitor C1 connected in parallel to condition and stabilize the voltage signal. The capacitor C1 filters out noise from the voltage divider output to produce a clean measurement signal at the output Vout. The optocoupler O translates this signal into an isolated output that can be processed by the control electronics to monitor and control system operation.

An optocoupler, or optoisolator, is designed to transfer electrical signals between two isolated circuits using light as the medium, ensuring galvanic isolation between the input and output. This isolation protects components from high voltages or voltage spikes. An optocoupler may include two main components: a light-emitting diode (LED) and a light-sensitive device, such as a phototransistor or photodiode, on the output side. When a voltage is applied to the LED, it emits light proportional to the current flowing through it. This light travels across a transparent dielectric barrier, such as glass or plastic, that separates the LED and the light-sensitive device. The barrier allows light transmission while maintaining electrical isolation. The light-sensitive device detects the light and converts it back into an electrical signal, which can then be used to drive downstream circuits. The output signal is proportional to the input, enabling signal transmission.

The efficiency of the optocoupler depends on the coupling between the LED and the light-sensitive device, which is quantified by the current transfer ratio (CTR), the ratio of output current to input current. Optocouplers are available in various configurations to suit different applications. Phototransistor-based optocouplers offer higher current outputs but slower response times, making them suitable for low-frequency applications. Photodiode-based optocouplers, on the other hand, are faster and better suited for high-speed data transmission. The response speed, isolation voltage, and CTR are parameters that determine an optocoupler's performance.

As mentioned above, the circuit employs the resistor bank R0 and optocoupler O to achieve electrical isolation while sensing the HV DC bus voltage Vdc. The current Id flowing through the resistor bank R0 is given by Id=Vdc/R0, which drives the light-emitting diode of the optocoupler O. This, in turn, generates the proportional current Ip through the phototransistor of the optocoupler O, governed by the relationship Ip/Id=k, where k is the optocoupler's transfer constant and the output voltage of the circuit is Vout=Ip*R3. The output voltage Vout can then be derived as Vout=k*(R3/R0)*Vdc, allowing for accurate measurement of Vdc based on the value of Vout. The inclusion of the optocoupler O facilitates electrical isolation between the high-voltage and low-voltage sides of the system 24, protecting components from high-voltage during conditions such as HV battery leakage detection or laboratory isolation tests where 1000 VDC is applied between the HV DC bus and the chassis or ISC housing.

In addition to voltage sensing, the circuit also serves as a passive discharge mechanism for the HV capacitor Cdc. The current Id flowing through the resistor bank R0 continuously discharges the energy stored in the HV capacitor Cdc, reducing it to a low voltage level. This functionality eliminates the need for a separate passive discharge resistor, combining the passive discharge capability with the voltage sensing function in a single integrated circuit. Furthermore, the circuit includes a fault detection feature to identify open-circuit conditions in the passive discharge path. If the resistor bank R0 develops an open circuit, the discharge current Id drops to zero, causing the output voltage Vout to also fall to zero. This condition is flagged as a fault, indicating that the HV capacitor Cdc may remain charged and signaling the presence of residual high voltage in the ISC.

By combining these three functions—HV DC bus voltage sensing with electrical isolation, HV capacitor passive discharging, and open-circuit fault detection—into a single compact design, the solution offers benefits. The use of the optocoupler O allows high voltage to be effectively blocked from reaching components during certain scenarios. Additionally, the integrated fault detection capability ensures that any issues with the passive discharge path can be identified and addressed.

While the exemplary embodiments described above illustrate certain aspects of the disclosed systems and methods, they are not intended to cover all possible implementations. The terminology used in this specification is for descriptive purposes only and is not intended to impose any limitations on the scope of the disclosure. It should be understood that modifications, alterations, and variations can be made without departing from the essence or broader principles described herein. Additionally, the features and elements of the various embodiments may be combined in different ways to create additional implementations within the scope of this disclosure.

What is claimed is:

1. A vehicle comprising:
an electrical system including a traction battery, a resistor bank, an inverter electrically connected between the traction battery and resistor bank, and a capacitor electrically connected between the traction battery and inverter; and
circuitry, including an optocoupler configured to be driven by current through the resistor bank, arranged to produce an output voltage electrically isolated from the inverter and indicative of a voltage of the traction battery.

2. The vehicle of claim 1, wherein the resistor bank is configured to discharge the capacitor.

3. The vehicle of claim 1, wherein the resistor bank and optocoupler are configured such that an open circuit condition in the resistor bank results in the output voltage being zero.

4. The vehicle of claim 1 further comprising a control board, wherein the resistor bank and circuitry are on the control board.

5. The vehicle of claim 1 further comprising a control board, wherein the circuitry is on the control board and the resistor bank is not on the control board.

6. The vehicle of claim 1, wherein the circuitry includes a resistor and capacitor electrically connected in parallel.

7. The vehicle of claim 1 further comprising leakage detecting circuits electrically connected between terminals of the traction battery and a ground.

8. A method comprising:
generating an output voltage indicative of a DC bus voltage of an automotive power system via circuitry including an optocoupler arranged to be driven by current through a resistor bank connected in parallel with a traction battery and such that an inverter is electrically connected between the resistor bank and traction battery.

9. The method of claim 8 further comprising dissipating energy stored in a capacitor electrically connected between the traction battery and inverter via the resistor bank.

10. An automotive power system comprising:
a motor;
a traction battery and inverter configured to power the motor via a DC bus;
a resistor bank connected across the DC bus; and
an optocoupler configured to produce an output current proportional to a current on the DC bus and flowing through the resistor bank.

11. The automotive power system of claim 10 further comprising a resistor configured to produce a voltage drop proportional to a voltage across the DC bus responsive to the output current flowing through the resistor.

12. The automotive power system of claim 11 further comprising a capacitor connected across the DC bus and between the traction battery and inverter, wherein the resistor bank is configured to discharge energy from the capacitor.

13. The automotive power system of claim 12, wherein the inverter is connected between the capacitor and resistor bank.

14. The automotive power system of claim 10 further comprising a control board, wherein the resistor bank and optocoupler are on the control board.

15. The automotive power system of claim 10 further comprising a control board, wherein the optocoupler is on the control board and the resistor bank is not on the control board.

16. The automotive power system of claim 10 further comprising leakage detection circuits connected with terminals of the traction battery.
